(19) United States
(12) Patent Application Publication
(10) Pub. No.: US 2012/0078716 A1
(43) Pub. Date: Mar. 29, 2012

(54) Consumer-Focused Marketing And Consumer Task Management

(75) Inventors: Erik S. Ross, Charlotte, NC (US); Susan S. Thomas, Gastonia, NC (US); Ekaterina A. Homyakova, Charlotte, NC (US)

(73) Assignee: BANK OF AMERICA CORPORATION, Charlotte, NC (US)

(21) Appl. No.: 12/894,109

(22) Filed: Sep. 29, 2010

(51) Int. Cl. G06Q 30/00

(52) U.S. Cl. 705/14.53

(57) ABSTRACT

An organization may identify target groups of consumers based on credit data meeting one or more pre-defined criteria and offer the identified individuals products and/or services that include favorable rates, benefits and/or incentives related to activities regularly engaged in by the individuals. Credit data may be mined from, for example, a credit bureau to identify individuals with credit scores in various percentiles as compared to all other consumers in a particular market or geographic region. Various types of transaction data associated with these individuals may then be obtained and analyzed to determine activities (e.g., tasks, chores, errands, activities, etc.) repeatedly engaged in by at least some percentage of the identified individuals, which may then be used as bases for offering certain products and/or services that include incentives or benefits more-specifically tailored to potential interests. The organization may also identify and select channels of communication for presenting product and/or service offerings to a target group of individuals based on recognized transaction patterns of the group.

### FIELD

Aspects of the disclosure relate to identifying individuals as potential customers of an organization based on one or more characteristics of the individuals. More specifically, aspects of the disclosure relate to identifying individuals as potential customers based on financial characteristics of the individuals and targeting one or products or service offerings to the identified individuals.

### BACKGROUND

As consumers continue to develop more complicated and busy working and personal lives while maintaining their desire to keep their privacy tightly sealed, finding effective ways to market new products and services to them becomes increasingly difficult. Especially with respect to products that are designed and developed without any particular consumer in mind and mass marketed through every available channel of communication, many consumers either overlook or choose to ignore product offerings that they might otherwise find helpful and valuable if presented to them in a different manner or with one or more additional features tailored more specifically to their tastes.

Identifying as closely as possible with the precise interests and needs of consumers when offering them new products and services is one aspect of a more effective and efficient marketing scheme. Another aspect relates to determining the channels of communication consumers are most receptive to receiving product and service offerings through, and/or the channels that consumers most actively utilize in their daily lives. Consumers preferences, both in terms of what a product has to offer, as well as the circumstances under which the product is offered, factor heavily into decision-making when developing a strategy of consumer outreach and marketing.

### BRIEF SUMMARY

In light of the foregoing background, the following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

One or more aspects described herein relate to identifying target groups of individuals (e.g., customers, consumers, clients, members, users, individuals, etc.) based on credit data (e.g., credit score, credit risk rating, etc.) that meets one or more criteria defined by an organization, and offering the individuals comprising these target groups products and/or services that include favorable rates, benefits and/or incentives related to activities regularly engaged in by the individuals. In some arrangements, credit data may be mined from, for example, a credit bureau to identify individuals with credit scores in the highest ten percent as compared to all other consumers in a particular market and/or geographic region (e.g., within the United States). Various types of transaction data associated with these individuals may be obtained and analyzed to determine one or more activities (e.g., tasks, chores, errands, activities, etc.) repeatedly engaged in by at least some percentage of the identified individuals. An organization (e.g., a financial institution) may use these activities as bases for offering these individuals various products and/or services that include certain incentives or benefits identified as being of potential interest to the individuals.

One or more other aspects described herein relate to identifying and selecting channels of communication for presenting product and/or service offerings to a target group of individuals based on recognized transaction patterns. For example, various transaction data may be analyzed to identify one or more types of transactions regularly engaged in by a target group of individuals. The organization may then determine that each time an individual of the target group engages in one of the identified types of transactions, a product offering relevant to the target group may be presented to the individual.

One or more other aspects described herein relate to negotiating reduced rates, added benefits and/or greater incentives with one or more vendors (e.g., providers of products/services associated with identified activities of a target group) for inclusion in new products offered to existing customers of the organization. Such existing customers may belong to any of the identified target groups, and may receive favorable rates or other added incentives from vendors upon being identified as customers of the organization. In at least one arrangement, the organization may offer vendors a guaranteed amount of business (e.g., a certain percentage of business from one or more identified target groups) in exchange for favorable rates for customers of the organization.

Aspects of the disclosure may be provided in a computer-readable medium having computer-executable instructions to perform one or more of the process steps described herein.

This summary is provided to introduce a selection of aspects of the disclosure in a simplified form that are further described below in the Detailed Description and accompanying figures. The summary is not intended to identify key features or essential features of the claimed subject matter, nor is it intended to be used to limit the scope of the claimed subject matter.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 is an illustrative block diagram of workstations and servers that may be used to implement the processes and functions of certain embodiments of the present disclosure;

FIG. 3 is a schematic diagram showing example communication paths for obtaining consumer credit data and presenting product offerings to target groups according to one or more aspects described herein;

FIG. 4 is a flowchart illustrating an example method of identifying a target group of individuals and offering new products or negotiated rates to the target group of individuals according to one or more aspects described herein; and

FIG. 5 is a flowchart illustrating an example method of determining product or service offerings for individuals of target groups based on identified recurring activity patterns of such individuals according to one or more aspects described herein.

### DETAILED DESCRIPTION

In the following description of various illustrative embodiments, reference is made to the accompanying drawings, which form a part hereof, and in which is shown by way of illustration various embodiments in which one or more aspects of the disclosure may be practiced. It is to be understood that other embodiments may be utilized and structural and functional modifications may be made without departing from the scope of the present disclosure.

By way of general introduction, one or more aspects described herein relate to an organization (e.g., a financial institution) obtaining consumer credit data (e.g., credit scores, credit risk ratings, etc.) based on one or more criteria defined by the organization, and using this credit data to identify groups of individuals with which to target certain products and/or services offered by the organization. In at least one arrangement, individuals may be grouped according to credit score (e.g., FICO credit score) percentiles and then each group targeted with one or more products and/or services of the organization that include various incentives and/or benefits associated with activities (e.g., tasks, chores, errands, activities, etc.) determined as being regularly engaged-in by at least some number of individuals of the group. For example, credit data may be mined or otherwise extracted and processed from a consumer credit bureau or similar type of consumer credit database to identify individuals (e.g., customers, clients, members, users, individuals, etc.) having credit scores in the highest ten percent as compared to all other consumers in a particular market or geographic region (e.g., within the United States).

Additionally, determining which activities are frequently or commonly engaged-in by individuals of a group may be based on different types of information and data available through a variety of sources, including social clubs, community organizations, social media networks and/or other similar groups to which individuals belong. In accordance with at least some aspects described herein, transaction data for the individuals of a group, which may include numerous different types of data that the organization (or some third party vendor) tracks and stores for various account transactions, may be obtained and analyzed to determine one or more recurring activities common to at least some threshold percentage of the group of individuals. The organization may use such activities as bases for identifying one or more incentives and/or benefits to include as part of a product or service offering that the organization desires to target towards the group. Other data may also be used for the same purpose in addition to or instead of transaction, and may include, for example, geographical location data of individuals, social network and/or social media data, and the like.

One or more other aspects described herein relate to identifying and selecting channels of communication for presenting product and/or service offerings of an organization to a target group of individuals according to detected transaction patterns. In at least one arrangement, various transaction data (e.g., mobility data, usage data, social media data, etc.) for a target group may be analyzed to identify one or more types of transactions regularly engaged in by individuals of the target group. The organization may then determine that each time an individual of the target group engages in one of the identified types of transactions, a product offering relevant to the target group may be presented to the individual.

According to additional aspects described herein, reduced rates, more benefits and/or greater incentives may be negotiated with one or more vendors (e.g., providers of products/services associated with identified activities of target group) for inclusion in new products offered to existing customers of the organization who are a part of one or more target groups of individuals. In one arrangement, an organization may offer vendors a guaranteed amount of business (e.g., a certain percentage of one or more identified target groups) in exchange for favorable rates for customers of the organization. Various other incentives and/or benefits may also be negotiated with vendors on behalf of existing customers of the organization in addition to or instead of favorable rates. In one example, the organization may solicit bids by numerous different vendors, each of which desires to obtain a guaranteed amount of business, in exchange for such added benefits, incentives and/or lower rates. Processes such as this may be referred to, for example, as reverse auctions, business-to-consumer auctions, procurement actions, as well as by other names all of which indicate sellers/vendors of a product and/or service are competing against one another to obtain business from buyers. An example of how an organization may utilize a reverse auction or similar-type approach in implementing a customer task management system includes identifying various tasks and chores familiar to the majority of individuals, such as shopping for groceries, picking-up/dropping-off dry-cleaning, getting oil changes, mowing the lawn, and numerous other activities considered by many to be time-consuming and inconvenient, and negotiating favorable rates with vendors, sellers, and providers associated with such tasks.

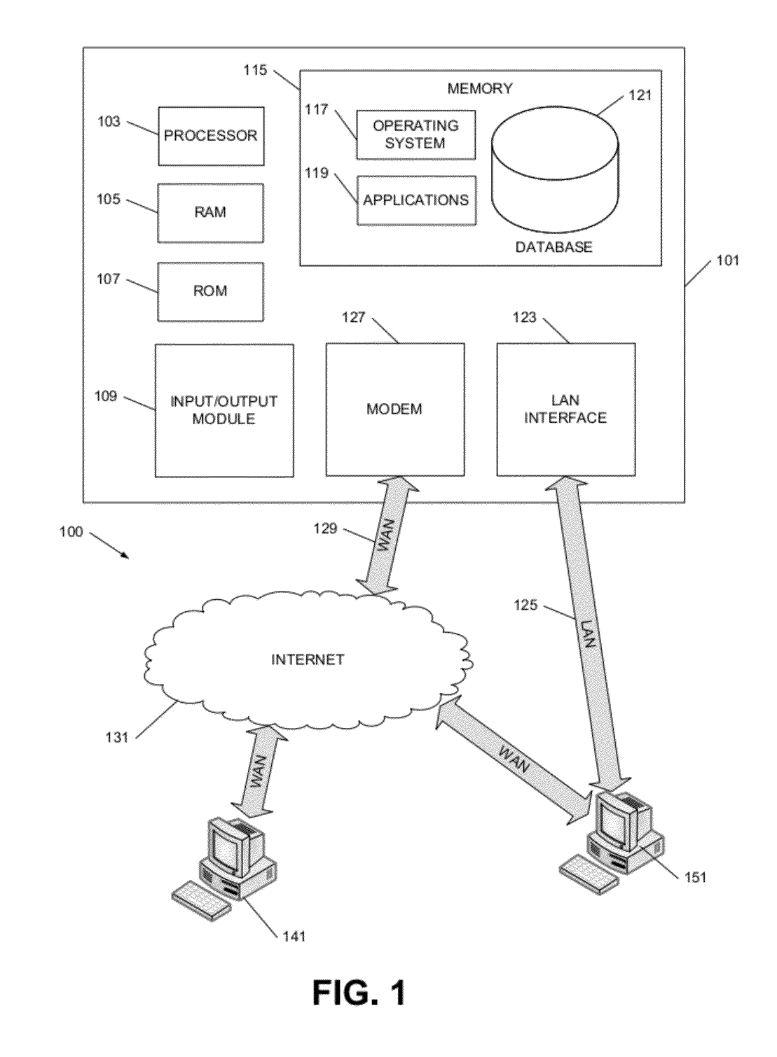

FIG. 1 illustrates a block diagram of a generic computing device 101 (e.g., a computer server) that may be used according to an illustrative embodiment of the disclosure. The computer server 101 may have a processor 103 for controlling overall operation of the server and its associated components, including RAM 105, ROM 107, input/output module 109, and memory 115.

Input/Output (I/O) 109 may include a microphone, keypad, touch screen, camera, and/or stylus through which a user of device 101 may provide input, and may also include one or more of a speaker for providing audio output and a video display device for providing textual, audiovisual and/or graphical output. Other I/O devices through which a user and/or other device may provide input to device 101 also may be included. Software may be stored within memory 115 and/or storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown). As described in detail below, the database 121 may provide centralized storage of characteristics associated with members of the organization, allowing interoperability between different lines of business of the organization that may reside at different physical locations.

Server 101 may operate in a networked environment 100 supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. Furthermore, any of a number of different communication protocols, such as TCP/IP, Ethernet, FTP, HTTP and the like, may be used within networked environment 100.

Additionally, an application program 119 used by the server 101 according to an illustrative embodiment of the disclosure may include computer executable instructions for invoking functionality related to providing access authorization for facilities and networks.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc., that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

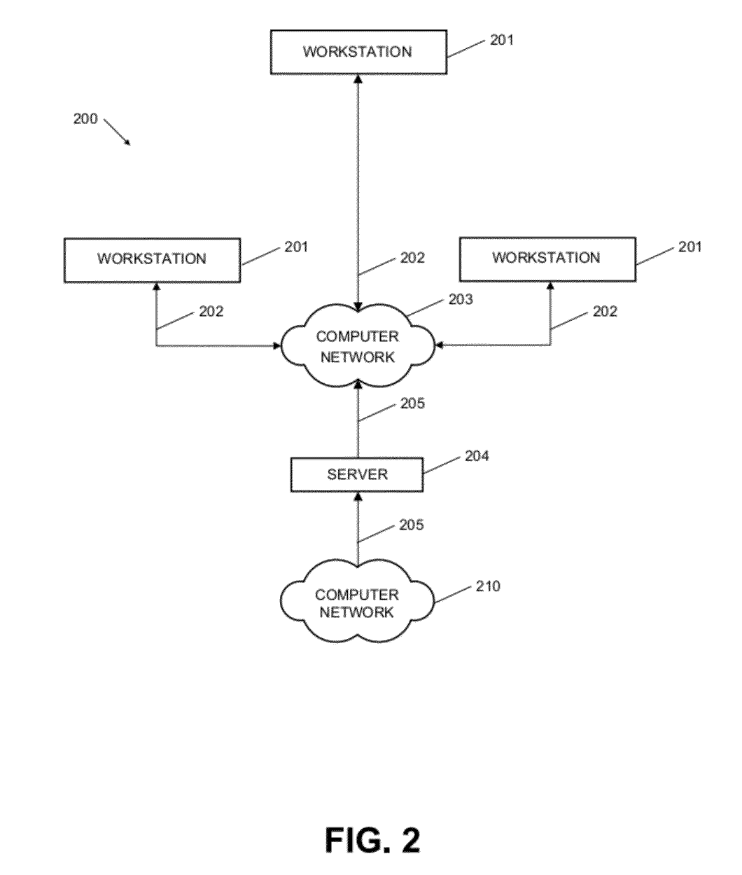

Referring to FIG. 2, an illustrative system 200 for implementing methods according to the present disclosure is shown. As illustrated, system 200 may include one or more workstations 201. Workstations 201 may be local or remote, and are connected by one or more communications links 202 to computer network 203 that is linked via communications links 205 to server 204. In system 200, server 204 may be any suitable server, processor, computer, or data processing device, or combination of the same. Server 204 may be used to process the instructions received from, and the request submitted by, one or more members of the organization.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

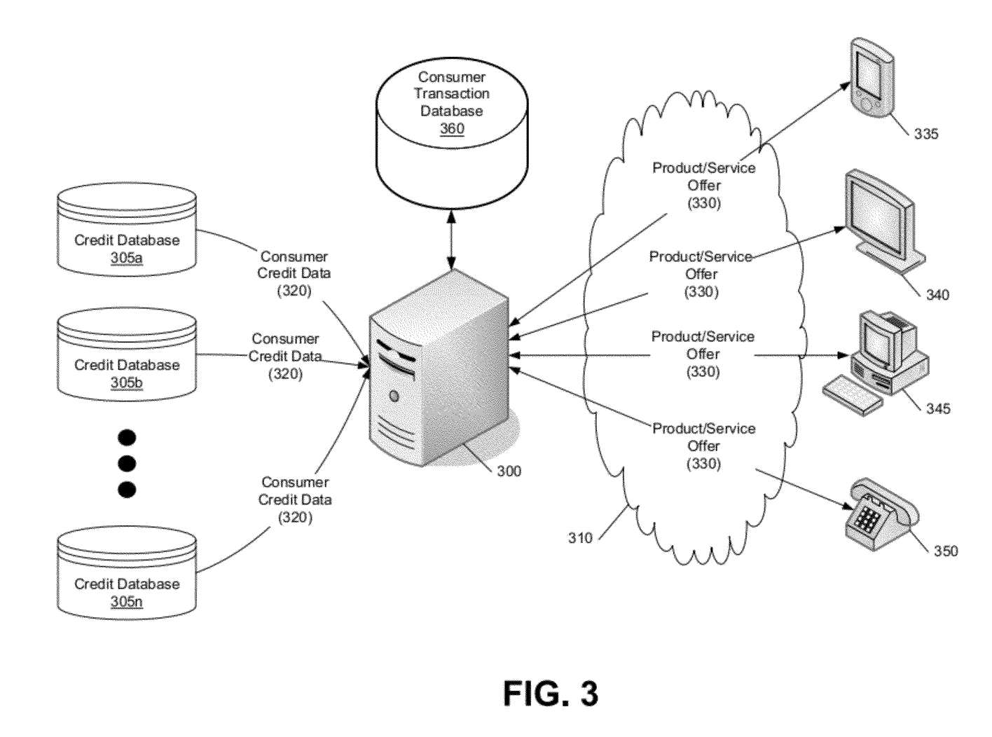

FIG. 3 illustrates an example network environment in which information may be communicated when obtaining consumer credit data and presenting product and/or service offerings to identified individuals of one or more target groups according to various aspects described herein. As shown in FIG. 3, marketing server 300, which in one or more arrangements may be a computer, server, processor, etc., associated with the organization (e.g., a financial institution), allows for communication with credit databases 305a through 305n (where “n” is an arbitrary number) to obtain consumer credit data 320. Marketing server 300 and credit databases 305a through 305n may, in some arrangements, communicate over a network (not shown), which may include, for example, the Internet or other similar network capable of carrying electronic communications between marketing server 300 and credit databases 305a through 305n. In one or more arrangements, credit databases 305a through 305n are maintained by one or more credit reporting agencies or bureaus that collect, analyze, and otherwise process various items of data relating to consumers' credit and, with various restrictions in place, make consumer credit data 320 available to third parties. In other arrangements, consumer credit data 320 may be extracted (e.g., mined, downloaded, retrieved, extracted, etc.) or otherwise obtained from one or more systems internal to an organization associated with marketing server 300. In such arrangements, marketing server 300 may not need to mine consumer credit data 320 from credit databases 305a through 305n, or may use a combination of consumer credit data 320 from credit databases 305a through 305n and consumer credit data extracted from various internal systems of the organization. Similar to marketing server 300, credit databases 305a through 305n may include computers, servers and/or other such processing devices capable of maintaining, transmitting and receiving electronic communications a network.

Also shown in FIG. 3 are communications between marketing server 300 and a variety of different types of remote receivers (e.g., 335, 340, 345 and 350 illustrated in FIG. 3), which may include one or more of a personal digital assistant 335, computer 345, television 340 and telephone device 350. Marketing server 300 may communicate with one or more of personal digital assistant 335, computer 345, television 340 and telephone device 350 over a network 310. Network 310 may be, for example, the Internet or other similar network capable of carrying electronic communications between marketing server 300 and personal digital assistant 335, computer 345, television 340 and telephone device 350. In at least one arrangement, personal digital assistant 335, computer 345, television 340 and telephone device 350 are maintained and operated by individuals of one or more target groups of individuals with which marketing server 300 communicates product and/or service offers 330. Such remote receivers may include one or more types of wearable devices (e.g., a computing device that may be included as a component of a larger portable or otherwise moveable device) capable of exchanging communications with marketing server 300 while an individual is using or carrying one or more other devices to which the wearable device belongs. Communications may be exchanged between marketing server 300 and such wearable or moveable devices with or without the knowledge of the individual. In other arrangements, personal digital assistant 335, computer 345, television 340 and telephone device 350 may be maintained and/or operated by agents of individuals belonging in the one or more target groups of individuals associated with receiving the product and/or service offers 330 from marketing server 300. For example, personal digital assistant 335, computer 345, television 340 and telephone device 350 may be associated with customers of an organization maintaining and operating marketing server 300. In still other arrangements, the remote receivers shown in FIG. 3 may be associated with individuals who are not customers of the organization associated with marketing server 300 or may be maintained by and associated with, for example, financial advisors of such individuals. Additionally, the remote receivers may receive product and/or service offers 330 from marketing server 300 as a result of the organization associated with marketing server 300 desiring to acquire the individuals as new customers.

Remote receivers (e.g., 335, 340, 345 and 350) may have bidirectional communication with marketing server 300 over network 310, such that information may be electronically transmitted between an organization associated with marketing server 300 and one or more individuals associated with the remote receivers in a quick, easy and secure manner. For example, instead of an organization, such as a financial institution offering new or improved products and/or services (e.g., product and/or service offers 330) via postal mail carrier to potential or existing customers of the organization, the organization may utilize a variety of other communication channels, one or more of which may be preferred by certain customers over other available channels. While one target group of individuals may be found to prefer to receive product offerings through email, another one or more target groups of individuals may prefer to listen to such offers over a telephone or watch advertisements of such offers on the television. It is to be appreciated by those skilled in the art that numerous other types of remote receivers may also communicate over network 310 with marketing server 300 in addition to or instead of remote receivers 335, 340, 345 and 350. It is also to be appreciated that various other types of communication channels (e.g., adaptations of television channels, radio signals, etc.) may also be preferred by individuals belonging to a target group in addition to or instead of those described above, and that the particular communication channels mentioned are not intended to limit the scope of the present disclosure in any way.

FIG. 3 also includes consumer transaction database 360, which may be utilized in conjunction with marketing server 300 to store and retrieve numerous items of information acquired, tracked, or otherwise obtained based on various activities of consumers. In one arrangement, such information may be based on consumer credit data 320 received from credit databases 305a through 305n, while in other arrangements the information maintained in consumer transaction database 360 may be systematically stored by an organization associated with marketing server 300. For example, consumer transaction database 360 may store information related to the types, frequency, and locations of transactions engaged in by individuals associated with remote receivers 335, 340, 345 and 350. In some arrangements these individuals may be customers of an organization maintaining marketing server 300, while in others these individuals may be potential or previous customers of the organization. The consumer transaction information maintained in consumer transaction database 360 may be used by marketing server 360 when determining a preferred channel of communication to use for sending product and/or service offers 330 to individuals of target groups.

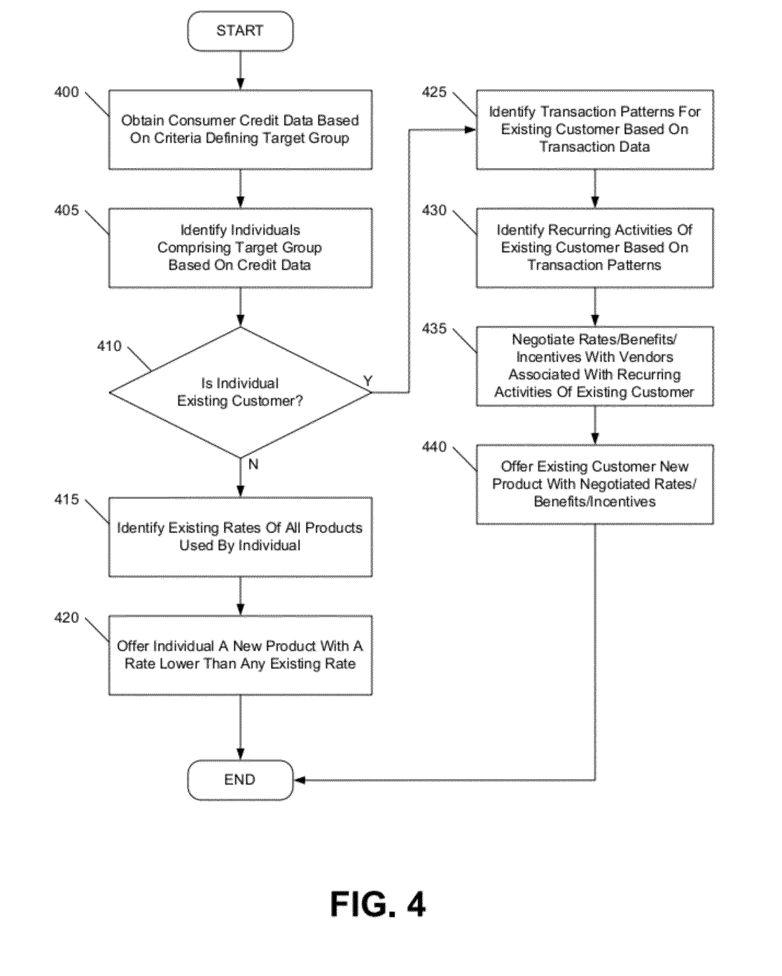

FIG. 4 is a flowchart illustrating an example method of identifying a target group of individuals and offering new products and/or services (e.g., products and/or services 330 shown in FIG. 3) to the individuals of such identified target groups, as well as offering new or negotiated rates for products to individuals of the target groups who are already existing customers of an organization associated with the products. In step 400, consumer credit data is obtained based on one or more criteria defining target groups as determined or established by an organization desiring to offer the target groups one or more products. The process then continues to step 405 where individuals are identified as being part of a target group or multiple target groups based on the consumer credit data obtained in step 400. For example, individuals associated with consumer credit data satisfying certain of the criteria may be placed into one or more target groups defined by the organization according to that criteria. In step 410, each individual of a target group is identified as an existing customer of the organization or not an existing customer of the organization.

If an individual is determined in step 410 to not be an existing customer of the organization, then in step 415 the existing rates of all products currently being used by the individual are identified. Such rates may be identified, for example, from the consumer credit data obtained for the individual in step 400. The process then continues to step 420 where the organization may offer the individual a new product of the organization with a rate lower than any of the existing rates identified in step 415. If, in step 410, the individual is instead determined to be an existing customer of the organization, then the process continues to step 425 where one or more transaction patterns may be identified for the individual based on transaction data obtained for the individual. As will be described in greater detail below, such transaction data may be obtained in a variety of different ways and may include numerous items of information related to transactions conducted by the individual in relation to the organization. In step 430, the transaction patterns identified in step 425 may be utilized to identify recurring (e.g., regular, repeated, etc.) activities of the existing customer. Once such activities are identified in step 430, then in step 435 the organization may negotiate one or more favorable rates, benefits and/or other incentives with vendors (e.g., services providers, goods sellers, business owners, etc.) associated with the activities of the existing customer. The process then goes to step 430 where the organization may offer the existing customer a new or upgraded product that includes the negotiated, more favorable rate, benefit and/or incentive.

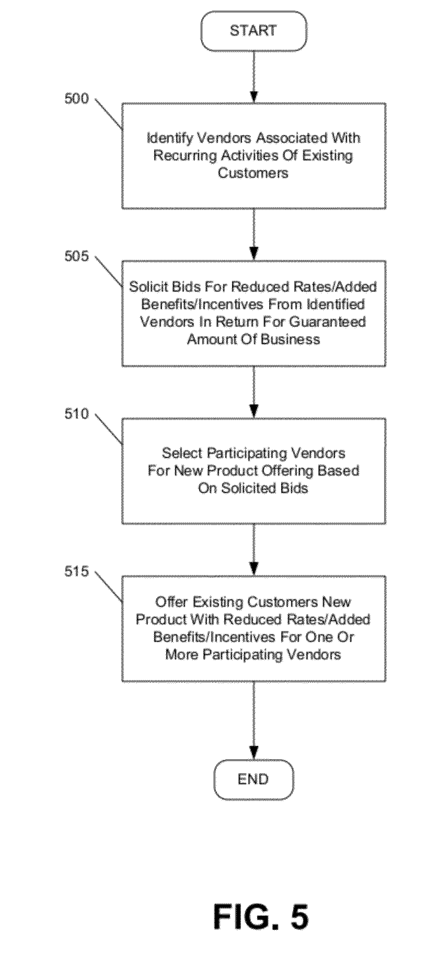

FIG. 5 is a flowchart illustrating an example method of determining product or service offerings for individuals of target groups based on identified recurring activity patterns of such individuals. In one or more arrangements these individuals may be customers of the organization offering the product or service, while in other arrangements such individuals may instead be potential customers and/or previous customers of the organization. Although FIG. 5 is described in the context of existing customers of an organization, the steps outlined below may also be used by the organization to select various products and/or services to offer target groups that include individuals who are not already customers of the organization.

The process begins at step 500 where vendors (e.g., services providers, goods sellers, business owners, etc.) associated with various recurring or regular activities of individuals of one or more target groups may be identified. As described herein, recurring activities of individuals in a target group defined, for example, by one or more criteria established by the organization, may be based on transaction data associated with various pieces of information related to or surrounding transactions engaged in by the individuals. Such transaction data may, for example, be stored or maintained in a database of the organization (e.g., consumer transaction database 360 shown in FIG. 3), or alternatively may be extracted, received, or otherwise obtained through various other means, such as from one or more entities or databases outside of the organization. Non-limiting examples of such transaction data include data about the types, frequencies, and locations of certain transactions engaged in by the individuals, and may include varying amounts of detail. For example, transaction data may include very basic information, such as a location of a transaction, a generic identifier of the type of the transaction and an amount of currency involved in the transaction. In other arrangements, transaction data may provide a much greater level of detail, including an identification of a vendor involved in the transaction, a good or service that was purchased or sold in the transaction, and the like.

Transaction data about the individuals of a target group of the organization may be analyzed for one or more patterns to identify various recurring (e.g., regular, repeated, etc.) activities common amongst the individuals. In some arrangements, an activity may be considered to be a recurring or regularly repeated activity of the target group if it is connected to at least some threshold number of the individuals comprising the target group. For example, in a target group comprised of thirty individuals, an activity (e.g., grocery shopping, dry-cleaning, getting gasoline, etc.) performed at least once every two weeks by fifteen or more of the individuals may be identified as a recurring activity for that target group. It is to be understood that the threshold number of individuals, the frequency of the activity, and the activities mentioned above are only for illustrative purposes and numerous other variables and/or metrics associated with such variables may be used in addition to or instead of those described in the example. Additionally, an organization may identify recurring activities of individuals of target groups in a variety of other ways and by utilizing numerous other types of transaction data.

Referring back to step 500 of FIG. 5, the recurring activities of a target group of individuals may be used to identify one or more vendors associated with each of the activities. For example, if it is determined that one of the recurring activities of a target group is dry-cleaning their clothing, then one or more dry-cleaners within a geographic area, zip code, neighborhood, etc., may be identified in step 500. The process then continues to step 505 where the organization may solicit bids for reduced rates, additional benefits or greater incentives from the identified vendors in exchange for promising the vendors a particular amount of business from the target group of individuals. In step 510, the organization may select one or more of the identified vendors based on the bids received, and then in step 515 offer the individuals comprising the target group a new product that includes the reduced rates, additional benefits and/or greater incentives.

Although specific examples of carrying out the aspects of the disclosure have been described, those skilled in the art will appreciate that there are numerous variations and permutations of the above-described systems and methods that are contained within the spirit and scope of the disclosure as set forth in the appended claims. Additionally, numerous other embodiments, modifications and variations within the scope and spirit of the appended claims will occur to persons of ordinary skill in the art from a review of this disclosure.

We claim:

1. A method comprising:
identifying one or more target groups of individuals based on consumer credit data obtained from one or more consumer credit data sources and measured against one or more criteria defining each of the one or more target groups of individuals;
identifying one or more activities associated with each of the one or more target groups based on transaction data about the individuals of each of the one or more target groups;
identifying one or more product offerings for the individuals of each of the one or more target groups, the one or more product offerings being different for each of the one or more target groups and being based on the one or more activities associated with each of the one or more target groups;
identifying a preferred communication channel for each of the one or more target groups, the preferred communication channel being one of a plurality of communication channels for communicating the one or more product offerings to the individuals of each of the one or more target groups, and the preferred communication channel being identified based on a response level indicated by the transaction data about the individuals of each of the one or more target groups; and
communicating the one or more product offerings to the individuals of each of the one or more target groups using the preferred communication channel for each of the one or more target groups.

2. The method of claim 1, further comprising:
determining a preferred communication channel of the plurality of communication channels is being utilized by an individual of a target group of the one or more target groups;
identifying the target group of the one or more target groups in which the individual belongs; and
communicating the one or more product offerings for the individuals of the identified target group to the individual using the preferred communication channel being utilized by the individual.

3. The method of claim 1, wherein the identifying the one or more activities associated with each of the one or more target groups includes:
retreiving the transaction data about the individuals of each of the one or more target groups from a consumer transaction database;
detecting one or more transaction patterns in the retrieved transaction data; and
identifying the one or more activities based on the detected one or more transaction patterns.

4. The method of claim 1, further comprising:
identifying vendors of the one or more activities associated with each of the one or more target groups;
negotiating an agreement with the vendors for providing the one or more activities associated with each of the one or more target groups to the individuals of each of the one or more target groups; and
incorporating the agreement with the vendors into the one or more product offerings identified for the individuals of each of the one or more target groups.

5. The method of claim 4, wherein the negotiating the agreement with the vendors for providing the one or more activities includes:
receiving bids for providing the one or more activities from a plurality of vendors; and
selecting, based on the received bids, at least one vendor of the plurality of vendors for providing each of the one or more activities to the individuals of each of the one or more target groups.

6. The method of claim 1, wherein the consumer credit data comprises one or more of credit risk ratings, credit scores, payment histories, revolving accounts and installment accounts, credit histories and new credit inquiries.

7. The method of claim 1, wherein the one or more activities associated with each of the one or more target groups includes

8. One or more computer-readable media storing computer-readable instructions that, when executed by at least one computer, cause the at least one computer to perform a method of:
identifying one or more target groups of individuals based on consumer credit data obtained from one or more consumer credit data sources and measured against one or more criteria defining each of the one or more target groups of individuals;
identifying one or more activities associated with each of the one or more target groups based on transaction data about the individuals of each of the one or more target groups;
identifying one or more product offerings for the individuals of each of the one or more target groups, the one or more product offerings being different for each of the one or more target groups and being based on the one or more activities associated with each of the one or more target groups;
identifying a preferred communication channel for each of the one or more target groups, the preferred communication channel being one of a plurality of communication channels for communicating the one or more product offerings to the individuals of each of the one or more target groups, and the preferred communication channel being identified based on a response level indicated by the transaction data about the individuals of each of the one or more target groups; and
communicating the one or more product offerings to the individuals of each of the one or more target groups using the preferred communication channel for each of the one or more target groups.

9. The one or more computer-readable media of claim 8, the computer-readable instructions that, when executed by at least one computer, further cause the at least one computer to perform:
determining a preferred communication channel of the plurality of communication channels is being utilized by an individual of a target group of the one or more target groups;
identifying the target group of the one or more target groups in which the individual belongs; and
communicating the one or more product offerings for the individuals of the identified target group to the individual using the preferred communication channel being utilized by the individual.

10. The one or more computer-readable media of claim 8, the computer-readable instructions that, when executed by at least one computer, further cause the at least one computer to perform:
retreiving the transaction data about the individuals of each of the one or more target groups from a consumer transaction database;
detecting one or more transaction patterns in the retrieved transaction data; and
identifying the one or more activities based on the detected one or more transaction patterns.

11. The one or more computer-readable media of claim 8, the computer-readable instructions that, when executed by at least one computer, further cause the at least one computer to perform:
identifying vendors of the one or more activities associated with each of the one or more target groups;
negotiating an agreement with the vendors for providing the one or more activities associated with each of the one or more target groups to the individuals of each of the one or more target groups; and
incorporating the agreement with the vendors into the one or more product offerings identified for the individuals of each of the one or more target groups.

12. The one or more computer-readable media of claim 11, the computer-readable instructions that, when executed by at least one computer, further cause the at least one computer to perform:
receiving bids for providing the one or more activities from a plurality of vendors; and
selecting, based on the received bids, at least one vendor of the plurality of vendors for providing each of the one or more activities to the individuals of each of the one or more target groups.

13. The one or more computer-readable media of claim 8, wherein the consumer credit data comprises one or more of credit risk ratings, credit scores, payment histories, revolving accounts and installment accounts, credit histories and new credit inquiries.

14. A system comprising:
at least one database configured to maintain transaction data for a plurality of target groups of individuals; and
at least one computing device, operatively connected to the at least one database, configured to:
obtain consumer credit data from one or more consumer credit data sources;
identify the plurality of target groups of individuals based on the consumer credit data measured against one or more criteria defining each of the plurality of target groups of individuals;
identify one or more activities associated with each of the plurality of target groups based on the transaction data for the plurality of target groups of individuals maintained by the at least one database;
identify one or more product offerings for the individuals of each of the plurality of target groups, the one or more product offerings being different for each of the plurality of target groups and being based on the one or more activities associated with each of the plurality of target groups;
identify a preferred communication channel for each of the plurality of target groups, the preferred communication channel being one of a plurality of communication channels for communicating the one or more product offerings to the individuals of each of the plurality of target groups, and the preferred communication channel being identified based on a response level indicated by the transaction data for the individuals of each of the plurality of target groups; and
communicate the one or more product offerings to the individuals of each of the plurality of target groups using the preferred communication channel for each of the plurality of target groups.

15. The system of claim 14, the at least one computing device further configured to:
determine a preferred communication channel of the plurality of communication channels is being utilized by an individual of a target group of the plurality of target groups;
identify the target group of the plurality of target groups in which the individual belongs; and
communicating the one or more product offerings for the individuals of the identified target group to the individual using the preferred communication channel being utilized by the individual.

16. The system of claim 14, the at least one computing device further configured to:
retrieve the transaction data for the plurality of target groups of individuals from the at least one database;
detect one or more transaction patterns in the retrieved transaction data; and
identify the one or more activities based on the detected one or more transaction patterns.

17. The system of claim 14, the at least one computing device further configured to:
identify vendors of the one or more activities associated with each of the plurality of target groups;
negotiating an agreement with the vendors for providing the one or more activities associated with each of the one or more target groups to the individuals of each of the one or more target groups; and
incorporating the agreement with the vendors into the one or more product offerings identified for the individuals of each of the one or more target groups.

18. The system of claim 17, the at least one computing device further configured to:
receive bids for providing the one or more activities from a plurality of vendors; and
selecting, based on the received bids, at least one vendor of the plurality of vendors for providing each of the one or more activities to the individuals of each of the plurality of target groups.

19. The system of claim 14, wherein the consumer credit data obtained from the one or more consumer credit data sources comprises one or more of credit risk ratings, credit scores, payment histories, revolving accounts and installment accounts, credit histories and new credit inquiries.

20. An apparatus comprising:
a processor; and
a memory storing computer-readable instructions that, when executed by the processor, cause the processor to perform:
identifying one or more target groups of individuals based on consumer credit data obtained from one or more consumer credit data sources and measured against one or more criteria defining each of the one or more target groups of individuals;
identifying one or more activities associated with each of the one or more target groups based on transaction data about the individuals of each of the one or more target groups;
identifying one or more product offerings for the individuals of each of the one or more target groups, the one or more product offerings being different for each of the one or more target groups and being based on the one or more activities associated with each of the one or more target groups;
identifying a preferred communication channel for each of the one or more target groups, the preferred communication channel being one of a plurality of communication channels for communicating the one or more product offerings to the individuals of each of the one or more target groups, and the preferred communication channel being identified based on a response level indicated by the transaction data about the individuals of each of the one or more target groups; and
communicating the one or more product offerings to the individuals of each of the one or more target groups using the preferred communication channel for each of the one or more target groups.

21. The apparatus of claim 20, wherein the processor is further configured to perform:
retreiving the transaction data about the individuals of each of the one or more target groups from a consumer transaction database;
detecting one or more transaction patterns in the retrieved transaction data;
identifying the one or more activities based on the detected one or more transaction patterns;
identifying vendors of the one or more activities associated with each of the one or more target groups;
negotiating an agreement with the vendors for providing the one or more activities associated with each of the one or more target groups to the individuals of each of the one or more target groups; and
incorporating the agreement with the vendors into the one or more product offerings identified for the individuals of each of the one or more target groups.
